(19) United States
(12) Patent Application Publication
(10) Pub. No.: US 2001/0035313 A1
(43) Pub. Date: Nov. 1, 2001

(54) Ladder standoff for corners

(76) Inventors: Loren George Uridel, Fruitland Park, FL (US); Steven A. Powell, Fruitland Park, FL (US)

Correspondence Address: Joseph H. McGlynn, 6111 Saddle Horn Dr., Faifax, VA, 22030, US

(21) Appl. No.: 09/842,149

(22) Filed: Apr. 26, 2001

Related U.S. Application Data
(60) Provisional application No. 60/200,750, filed on May 1, 2000.

(51) Int. Cl. E06C 7/42; E06C 7/06

(52) U.S. Cl. 182/107; 182/214

(57) ABSTRACT

An attachment for the top rungs of a ladder which has two U-shaped channels that fit over two rungs of the ladder and a bracket with a V-shaped brace attached that can fit around corners. A lower attachment portion is used to level the ladder on uneven ground.

This invention claims the benefit of the U.S. Provisional application 60/200,750 filed on May 1, 2000.

### BACKGROUND OF THE INVENTION

The present invention relates to a ladder accessory system that has channels which fit over the top of the ladder and a V-shaped bracket attached to fit around corners and a leveler on the ladder's lower portion.

Accessories that are used with conventional ladders are known in the prior art. For example, in one prior invention a ladder leveler has a channel attached to the foot of a ladder and a second portion which has a spring biased leveler which engages in selected holes in a first portion to level the ladder.

Another ladder accessory discloses a ladder leveler which has a channel attached to the foot of a ladder and a second portion which has a spring biased pin which engages selected holes in a first portion to level the ladder.

A ladder leveler is disclosed in another invention which has a pair o f sleeve members attached to the bottom of a ladder and one of which has a flange which is captured by a guide rail on the other member.

In another invention an attachment for a ladder is disclosed which has means to attach it to the top of a ladder and which has a V-shaped portion to fit around corners.

Another attached for a ladder invention discloses means to attach it to the top of a ladder and a V-shaped portion to fit around corners and a foot leveler attached to the bottom of the ladder.

One ladder attachment has a U-shaped bracket attached to the top of a ladder to allow the ladder to stand off from the surface it leans against.

A ladder leveler is disclosed in another invention which has an inner square bar and an outer square tube which interconnects to adjust the height of a ladder leg.

Still another attachment for a ladder invention has means to attach it to the top of a ladder and has a V-shaped portion to fit around corners.

### DESCRIPTION OF THE PRIOR ART

Accessories that are used in conjunction with conventional ladders are disclosed in the prior art. For example, U.S. Pat. No. 1,179,391 to Bachman discloses a ladder leveler that has a channel attached to the foot of a ladder and a second portion which has a spring biased lever which engages selected holes in a first portion to level the ladder.

U.S. Pat. No. 2,936,849 to Larson discloses a ladder leveler which has a channel attached to the foot of a ladder and a second portion which has a spring biased pin which engages selected holes in a first portion to level the ladder.

U.S. Pat. No. 3,948,352 to Larson et al. discloses a pair of sleeve members attached to the bottom of a ladder and one of which has a flange which is captured by a guide rail on the other member.

U.S. Pat. No. 4,953,790 to Brewer et al. discloses an attachment for a ladder which has means to attach it to the top of a ladder and which has a V-shaped portion to fit around corners.

U.S. Pat. No. 5,012,895 to Santos discloses means to attach an accessory to the top of a ladder and a V-shaped portion to fit around corners and a foot leveler attached to the bottom of the ladder.

U.S. Pat. No. 5,121,814 to Southern discloses a U-shaped bracket attached to the top of a ladder to allow the ladder to stand off from the surface it leans against.

U.S. Pat. No. 5,609,222 to Horbacewicz et al. discloses a ladder accessory which has an inner square bar and an outer square tube which interconnect to adjust the height of a ladder leg.

U.S. Pat. No. 5,850,894 to Busenhart discloses an attachment for a ladder which has means to attach it to the top of a ladder and has a V-shaped portion to fit around corners.

In the present invention a ladder accessory system has an attachment for the top of a ladder which has two U-shaped channels that fit over the top two rungs of the ladder and a bracket with a V-shaped brace attached that can fit around corners along with a lower attachment portion to level the ladder on uneven ground, all as will be detailed in the specification that follows hereafter.

### SUMMARY OF THE INVENTION

This invention relates to a ladder accessory system which has an attachment for the top of a ladder having two U-shaped channels that fit over the top two rungs of the ladder and a V-shaped bracket that can fit around corners, along with a lower attachment portion to level the ladder on uneven ground.

It is the primary object of the present invention to provide for an improved ladder accessory system that fits the ladder into corners and can level the ladder.

Another object is to provide for such an accessory in which there are two channels which engage the top two rungs of the ladder and a supporting bracket for a V-shaped corner brace.

These and other objects and advantages of the present invention will become apparent to readers from a consideration of the ensuing description and the accompanying drawings.

### BRIEF DESCRIPTION OF THE DRAWINGS

FIG. 1 is a perspective view of the corner accessory used in the present invention showing the two rung engaging channels and the bracket with a V-shaped brace.

FIG. 2(a) is a top view of the brace and bracket used in the present invention.

FIG. 2(b) is a side view of the channels and supporting frame of the present invention's corner accessory system.

FIG. 3 is a perspective view of the underside of the corner accessory system used in the present invention.

FIG. 4 is a perspective view of the corner accessory system, as taken from one side.

FIGS. 5(a) and 5(b) are perspective views of the channel (FIG. 5(a)) and tube mount (FIGS. 5(b) ) for the ladder leveler.

FIG. 6 is a top view of the ladder lever extension system used in the present invention.

FIG. 7 is a perspective view of the ladder lever extension system on a conventional ladder.

FIG. 8 is a perspective view from the side showing the tube mount attached to the channel.

FIG. 9 is a top cross sectional view of an alternate attachment of a clamp used with the tube mount.

### DESCRIPTION OF THE PREFERRED EMBODIMENT

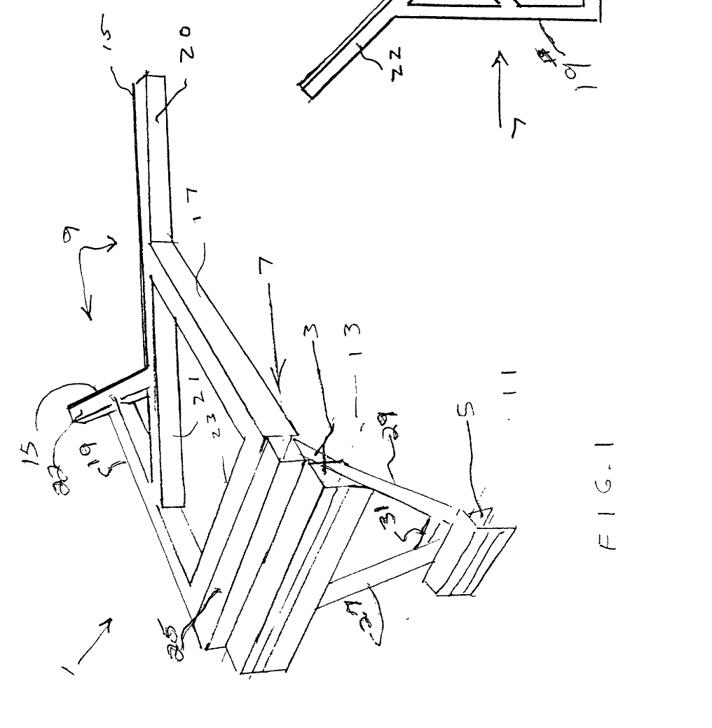

FIG. 1 is a perspective view of the corner accessory 1 used in the present invention showing the two rung U-shaped engaging channels 3 and 5 along with the bracket 7 with a V-shaped brace 9. The two top rungs 11 and 13 of the ladder, on which the spaced channels mount, are parallel to the length of the channels and are shown in dotted line format. The V-shaped brace consists of two fixed length members, each of which has a padded surface 15 located on the surface that engages the corner (here an outside corner) of a supporting surface, like a building or other structure. The surfaces 15 acts to prevent damage to the corners of the structure engaged by the ladder with its attached braces.

Fixed to the brace members 9 is the bracket 7. Bracket 7 has two arms 17 and 19 with arm 17 mounted to a first brace member 20. Arm 19 is mounted to the other, or second, brace member 22 and, also, to an extension 21 from the first brace member which is joined to the bracket arm 19. At the ladder end of the bracket 7, a cross frame member 23 is joined with a parallel portion 25, which portion is fixed to the channel structure used for attaching to the ladder's top two rungs.

Extending from the two end joining members 23 and 25 are two lateral, downwardly extending supports 27 and 29 that are fixed to members 23 and 25 and also to the lower end U-shaped channel 5. A small cross frame member 31 is fixed to supports 27 and 29 above channel 5. The top U-shaped channel 3 is fixed to member 25 with the whole structure 1 being joined together to form a rigid frame like system.

FIG. 2(a) is a top view of the joined brace 9 and bracket 7 used. In this view the brace's padded surfaces 15, which engage the surface of the outside corner on which the ladder rests, are more clearly shown. Each surface may extend substantially the entire length of each of the two brace members 20 and 22. The V-shaped brace is fixed to the padded facing surfaces.

FIG. 2(b) is a side view of the two rung engaging channels and its frame. In this view the V-shaped brace 9 and most of the bracket 7 are not shown. At the top of upper rung engaging channel 3 the rear most end 25 of the upper bracket 7 is shown.

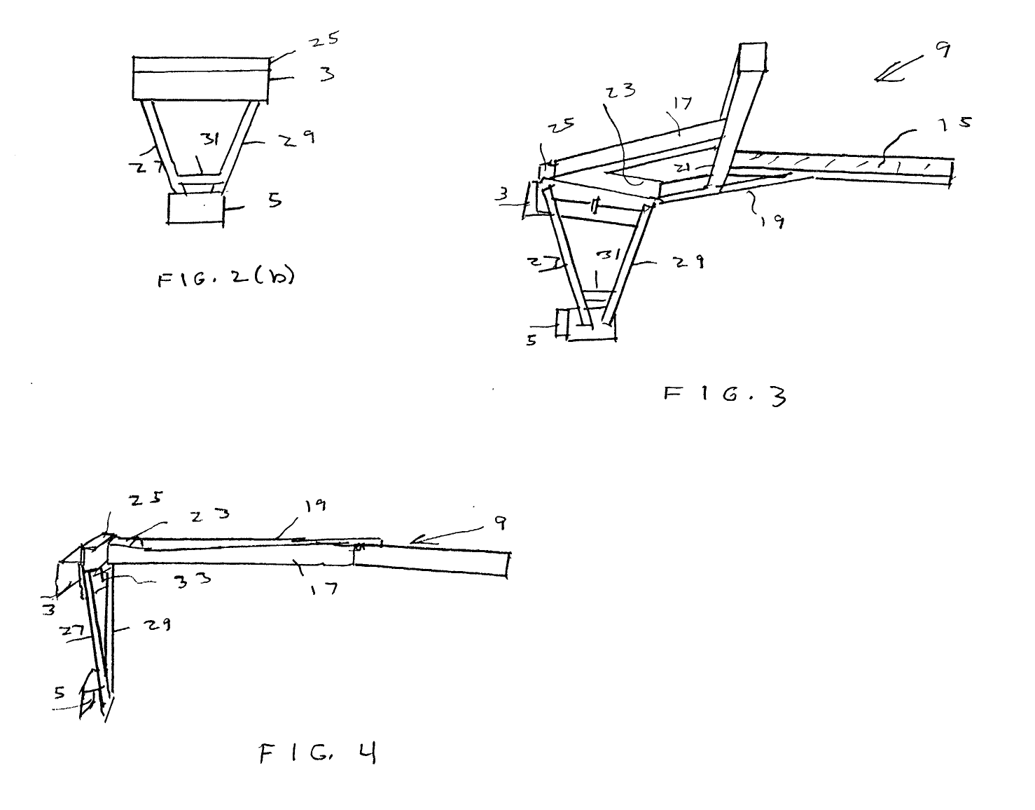

FIG. 3 is a perspective view of the corner accessory system used in the present invention taken from the underside. The down facing lower opened U-shaped channels 3 and 5 are more clearly visible in FIG. 3. Each channel has sufficient side edges such that it will not become dislodged from the straight ladder rung over which it is placed. One of the brace's padded surface 15 is also more clearly shown in this view.

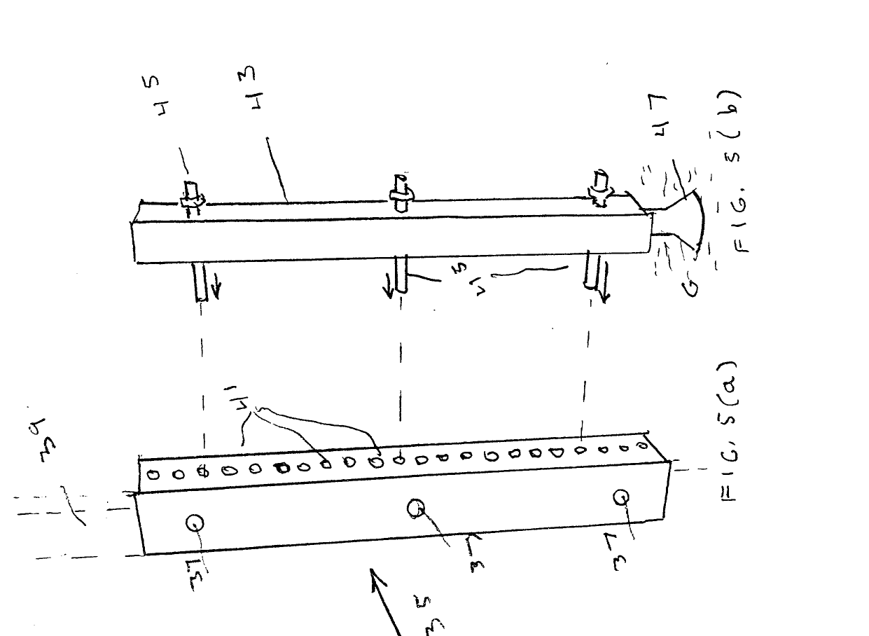

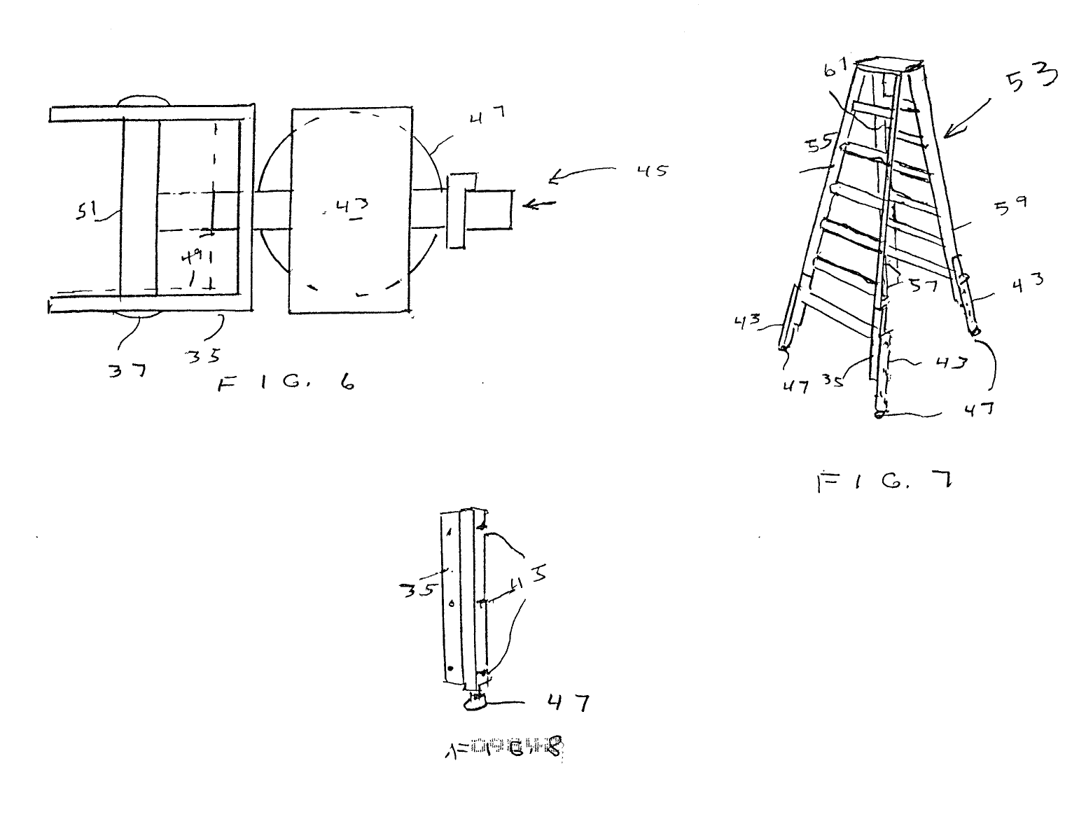

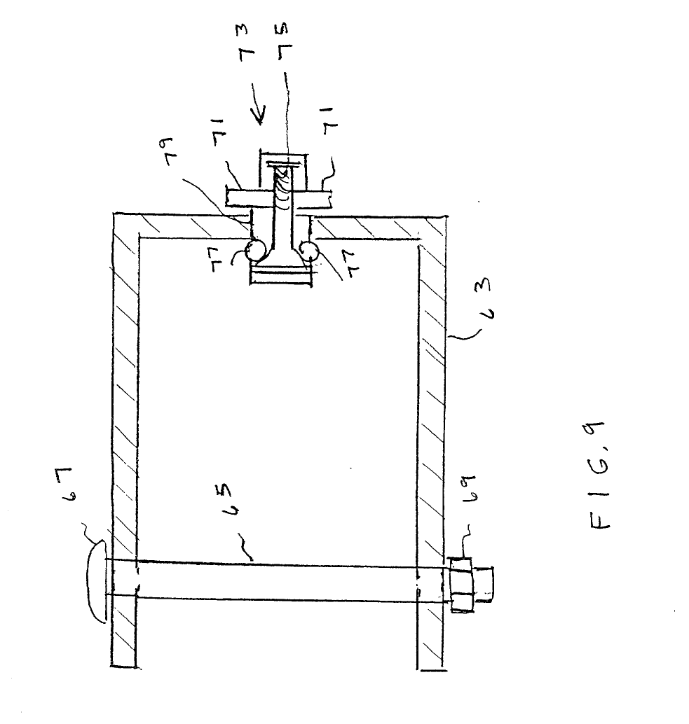

FIG. 4 is a perspective view of the corner accessory system 1 taken from a side. The end bracket portion 25 is joined to the upper ends of supports 27 and 29 and has an extending vertical apron surface 33 on which these supports bear and are fixed to. On the opposite side surface of end bracket portion 25 the facing surface of channel 3 is fixed to the bracket.

FIGS. 5(a) and 5(b) are perspective views of the two engaging elements, the channel 35 and the tube mount 43, used for the ladder leveler. One of the channel and tube mounts are mounted on each of the two vertical legs of a conventional ladder at their lower ends, as best shown in FIG. 7. In FIG. 5(a) the leg engaging channel 35 is shown. The channel has three spaced holes into which carriage bolts are inserted. The heads 37 for these bolts are shown within the channel holes. The free end of the bolts extend through the lower leg 39 of a ladder, as shown in dotted line format. Oriented ninety degrees from the channel side surface with the bolt heads 37 are a series of spaced holes 41 on a surface. The holes 41 extend along the length of the channel. The holes 41 act as receptors for spring loaded pins located on the tube mount of FIG. 5(b). When the ends of the three pins are inserted into three of the spaced holes 41 (out of the 22 holes shown) the tube mount is fixed in place relative to the ladder mounted U-shaped channel 35. By providing for many holes 41 in the channel, fixed to the ladder's legs, the vertical displacement of each leg extension may be independently adjusted to level the ladder when it is placed on uneven ground or other supporting surface.

The FIG. 5(b) mounting tube 43 has three spaced spring biased pins 45 along its length. The pins are spaced apart, relative to the holes 41 in channel 35, such that their free ends can be inserted into three of the holes 41 at the same time. The spring loaded or spring biased pins are normally forced such that their free ends are extended from the tube mount 43. When the pins are inserted into three of the holes 41 they face inwardly. With two such tube mounts, one on each side of the ladder legs, the three pins from each tube would be facing towards the three pins on the other tube but not necessarily at the same horizontal level.

By providing for many more mounting holes 41 than there are pins to be inserted, it should be clear that each tube mount for each ladder leg may be independently adjusted vertically over a considerable distance. At the lower end of mount 43 there is an adjustable pod or foot 47 which engages the ground G. This foot may be screw threaded into the bottom of the tube mount 43 to allow for a finer vertical adjustment than that provided for by the three pins inserted into the channel 35.

FIG. 6 is a top view of the ladder leveler extension system used in the present invention. In this view one of the pins 45 is shown biased inwardly towards the leg surface 49 of a ladder leg, shown in dotted line format. Normally, the strong internal spring of the pin would force the end of the pin in the direction of the arrow to extend inwardly to the left, as also shown by the dotted lines in the absence of the intervening ladder leg surface. The mounting bolt 51, whose bolt head 37 was previously shown, extends into and through the leg of the ladder to firmly mount the channel to the leg. Below the tubular mount 43, shown as a rectangle, is the lower supporting circular pod or foot 47, located to the outside of the ladder's leg surface.

FIG. 7 is a perspective view of the ladder leveler extension system on a conventional foldable step ladder 53. Each of the four vertical legs 55, 57, 59 and 61 of the ladder has the channel of FIG. 5(a) bolted to it at the lower end with a mounting tube of FIG. 5(b) engaging the channel. By positioning the mounting tube at different vertical heights along with the adjustable pod, variations in the lower supporting surface can be compensated for to level the ladder at each leg. If the ladder only had two legs, such as the extension ladder discussed with respect to FIGS. 1-4, then only two such channels and two tubular mounts would be necessary to level the ladder's legs.

FIG. 8 is a side view of the lower attached channel 35 with three pins 45 of the tube mount 43 engaged into the side holes of the channel. To disengage the mount from the channel, the exposed rear end of each pin is pulled outwardly while the mount is pulled away from the channel in the same direction. This action overcomes the normal biased action of the internal springs of the pins and permits the mount to be released from the channel holes. Since the pins extend in a generally horizontal direction, and the stepping force is directed vertically or downwardly, the inserted pins provide a sure support for the ladder's lower end. Aluminum may be used for making the channels and the tube mounts in a variety of different colors and patterned styles as desired.

FIG. 9 is a top cross sectional view of an alternate attachment channel clamp 63 for a tube mount. As before, there is a carriage bolt 65 having a bolt head 67 at one end and a nut 69 used to mount the clamp to a lower leg portion of a ladder. The tube mount, whose near side wall is partially shown as outer housing surface 71, is mounted by a pin 73 to the channel. A return spring 75 around the shaft of the pin insures it will, when released from its holding position, return to its original extended outward position. The inner pin surface has two ball locks 77 which extend to the sides of the channel hole 79, and which, when inserted, lock the pin and its tube mount to the channel. To do so the pin is forced in place. By first pressing to the left on the pin to dislodge the seated ball locks, and then pulling outwardly to the right on the pin, the pin and its ball locks may roll to a new position to become free of the channel hole 79.

It should be clear that the ladder extensions and their components shown in FIGS. 5(a) to FIG. 9, inclusive, can be used with the corner accessory shown in FIGS. 1-4, inclusive. Normally when used together a two leg extension ladder would be the ladder involved, although conceivably other types of conventional ladders could be adapted for this dual use of a corner accessory and leveler system.

Although the preferred embodiment of the present invention and the method of using the same has been described in the foregoing specification with considerable details, it is to be understood that modifications may be made to the invention which do not exceed the scope of the appended claims and modified forms of the present invention done by others skilled in the art to which the invention pertains will be considered infringements of this invention when those modified forms fall within the claimed scope of this invention.

What I claim as my invention is:

1. A ladder attachment system and leveler for a conventional ladder comprising:
a ladder having having two top spaced rungs and legs;
an attachment system having spaced U-shaped channels, each of which is adapted to fit over one of said two top rungs of the ladder to mount the attachment to the ladder;
said attachment system also having a V-shaped brace adapted to fit on the corner of a structure, said brace being connected to the U-shaped channels by a bracket; and
a leveler mounted on the legs of the ladder to level the ladder on an uneven supporting surface.

2. The ladder attachment system and leveler as claimed in claim 1, wherein said ladder has at least two lower legs with said leveler having a channel fixed to each of the lower legs with holes extending along its length; and
a removable tube mount with extending pins to engage said holes in the channel and adjustably mount the leveler to the legs of the ladder.

3. The ladder attachment system and leveler as claimed in claim 1, wherein said V-shaped brace has two padded surfaces used to engage a corner of a structure that supports said ladder.

4. The ladder attachment system and leveler as claimed in claim 3, also including two spaced bracket arms fixed to said V-shaped brace and extending towards said channels.

5. The ladder attachment system and leveler as claimed in claim 4, wherein said channels are oriented parallel to the top rungs of the ladder and have opened lower ends to receive the rungs.

6. The ladder attachment system and leveler as claimed in claim 5, wherein there is a brace extension which extends from a brace to one of the two bracket arms.
